(19) United States
(12) Patent Application Publication
(10) Pub. No.: US 2021/0350675 A1
(43) Pub. Date: Nov. 11, 2021

(54) SYSTEM AND METHOD FOR OPERATING FANTASY SPORTS LEAGUES

(71) Applicant: Big Money Brackets Inc., Westfield, IN (US)

(72) Inventors: Travis Ryan, Westfield, IN (US); John Smith, Westfield, IN (US)

(73) Assignee: Big Money Brackets Inc.

(21) Appl. No.: 17/313,648

(22) Filed: May 6, 2021

Related U.S. Application Data
(60) Provisional application No. 63/022,173, filed on May 8, 2020.

(51) Int. Cl. G07F 17/32; G06Q 50/34

(52) U.S. Cl. CPC G07F 17/3288; G07F 17/3244; G06Q 50/34; G07F 17/3276; G07F 17/3269

(57) ABSTRACT

A system for operating fantasy sports leagues comprising at least one-virtual room, a plurality of participants, and a plurality of draftable players with historical statistics. The participants select draftable players from the plurality of draftable players to build a roster of drafted players. The historical statistics comprise data based upon the drafted player's performance during an undisclosed time period. The virtual room assigns point values to the drafted players based upon the drafted player's performance during the undisclosed time period.

### CROSS-REFERENCE TO RELATED APPLICATIONS

The present application claims priority to U.S. Provisional Patent Application Ser. No. 63/022,173, filed May 8, 2020, which is incorporated herein by reference and having the title “SYSTEM AND METHOD FOR OPERATING FANTASY SPORTS LEAGUES.”

### TECHNICAL FIELD

The present disclosure relates to fantasy sports competitions, and more specifically, this disclosure relates to systems and methods for organizing fantasy sports leagues. In particular, the present disclosure provides a system for playing fantasy sports with a large number of participants. The system and method also allow participants to play fantasy sports year-round even during off seasons. The system and method also provide wagering opportunities based upon fantasy sports performance and competitions.

### BACKGROUND

In existing fantasy sports contests, each participant selects a team prior to or at the start of a sports season. The participant may select a full team, individual players from various teams, or a group of individuals from an athletic league. The participant is then responsible for managing their fantasy sports roster through acquiring new players, removing existing players from the roster, trading players, etc. In existing fantasy sports systems, the system provides participants with statistical information from real life sporting competitions. The statistics from real life sporting competitions for the various players on the participant's current roster determine the participant's fantasy scores. A participant's fantasy scores determine their placement within a league of participants.

Existing fantasy league systems are limited in participant capacity. Typically, participant capacity is capped due to a limited number of players in professional leagues. A typical fantasy league has no more than 14 participants. Each participant typically manages a team with a roster of 10 to 20 players. Thus, in a typical fantasy league, there are not enough available players from the professional league to allow more than 14 participants. Nonetheless, many fantasy sports players would like to compete in a league with more than 14 participants.

Additionally, current fantasy sports league systems are restricted in timing to the corresponding professional seasons. For example, a fantasy professional football league cannot begin before the first week of the NFL season, and must end upon the culmination of the season. Participants who enjoy fantasy professional football are therefore forced to wait for the beginning of the next NFL season before they can play in another fantasy league.

In view of the above, there is a need for systems and methods for operating fantasy sports leagues which allow improvements to the features of prior art fantasy sports leagues.

### SUMMARY

The present disclosure relates to a system and method for operating fantasy sports leagues. In at least one embodiment, the system for operating fantasy sports leagues comprises at least one virtual room, a plurality of participants, and a plurality of draftable players with respective historical performance statistics, wherein the participants select draftable players from the plurality of draftable players to build a roster of drafted players, wherein the respective historical statistics comprise data based upon the drafted player's performance during an undisclosed time period, and wherein the virtual room assigns point values to the drafted players based upon the drafted player's performance during the undisclosed time period. In an aspect of such an embodiment, the virtual room determines a winning participant and distributes rewards to the participants. In an aspect of such an embodiment, participants must pay a fee to enter the virtual room. In an aspect of such an embodiment, participants are afforded an opportunity to wager upon any fantasy sports related outcome. In an aspect of such an embodiment, the participants have a limited amount of time to select players from the draftable players. In an aspect of such an embodiment, the virtual room determines a winning participant and distributes rewards to the participants. In an aspect of such an embodiment, the participants have a limited amount of time to select players from the draftable players. In an aspect of such an embodiment, the drafted player's performance comprises a specified one-week period during the undisclosed time period. In some embodiments, the undisclosed period over which a player's performance statistics have been are gathered and provided to the system may be concealed from the participants during the roster selection process.

In at least one embodiment of the present disclosure, the method of operating fantasy sports leagues comprises allowing participants to enter a virtual room, displaying draftable players from an undisclosed time period, conducting a draft wherein participants select players from the draftable players to build a roster of drafted players, assigning scores to each drafted player based upon the drafted player's performance during the undisclosed time period, calculating scores for each roster based upon historical statistics for each drafted player, and comparing the scores of each participant. In an aspect of such an embodiment, the undisclosed time period comprises any historical time period with recordable statistics. In an aspect of such an embodiment, the method further comprises announcing a winner and paying out based upon the scores. In an aspect of such an embodiment, participants must pay a fee to enter the virtual room. In an aspect of such an embodiment, participants are afforded an opportunity to wager upon any fantasy sports related outcome. In an aspect of such an embodiment, the participants have a limited amount of time to select players from the draftable players. In an aspect of such an embodiment, the undisclosed time period comprises a historical decade with recordable statistics. In an aspect of such an embodiment, the drafted player's performance comprises a specified one-week period during the undisclosed time period.

In at least one embodiment of the present disclosure, the method for operating fantasy sports leagues comprises placing participants into divisions, conducting a draft for participants to select teams, placing participants into head-to-head competitions with participants within the division for the regular season, calculating scoring for each participant based upon the performance of the participant's roster, announcing regular season placements based upon the results of each head-to-head competition, placing participants into tiered tournament brackets based upon regular season performance, determining winners of each tiered tournament bracket and distributing winnings.

In at least one embodiment of the present disclosure, the system and method provides a fantasy sports league that allows an unlimited number of participants, which participants may be arranged in competition leagues for a competitive season or period and subsequently, for respective post-season competition, arranged into multiple bracket competition tournaments based on historical performance in a that sporting competitive season or period.

In at least one embodiment of the present disclosure, the system and method provide participants the ability to place wagers on the outcomes of his or her own drafted fantasy team and/or on the outcomes of drafted fantasy team of other participants.

In at least one embodiment of the present disclosure, the system and method provide participants the ability to select players from an undisclosed prior time period, then the system calculates the results based on historical performance data relating to that prior time period.

The system and method for operating fantasy sports leagues may be operated through a system that includes a node configured to act as a client on a network. The system further includes a server configured to communicate with the node over the network. The server includes at least one programmable processor and a machine-readable medium storing instruction that, when executed by the at least one programmable processor, cause the at least one programmable processor to perform operations. In some embodiments, the operations include creating a fantasy team having a plurality of players corresponding to one or more positions of a professional sports league, wherein the plurality of players comprise players in the professional sports league.

Systems and methods of the present disclosure are described as well as articles that comprise a tangibly embodied machine-readable medium operable to cause one or more machines (e.g., computers, etc.) to perform one or more of the operations described herein. Similarly, computer systems are also described that may include a processor and a memory coupled to the processor. The memory may include one or more computer programs that cause the processor to perform one or more of the operations described herein, the one or more computer programs comprising a non-transitory machine-readable medium storing instructions that, when executed by at least one programmable processor, cause the at least one programmable processor to perform operations described herein.

Other embodiments are also disclosed.

### BRIEF DESCRIPTION OF THE DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 depicts a fantasy sports simulation system, in accordance with some example embodiments of the present disclosure;

FIG. 2 shows a user interface according to an embodiment of the present disclosure;

FIG. 3 shows a user interface according to an embodiment of the present disclosure;

FIG. 4 shows a user interface according to an embodiment of the present disclosure;

FIG. 5 shows a user interface according to an embodiment of the present disclosure;

FIG. 6 shows a user interface according to an embodiment of the present disclosure;

FIG. 7 shows a user interface according to an embodiment of the present disclosure;

FIG. 8 shows a user interface according to an embodiment of the present disclosure;

FIG. 9 shows a user interface according to an embodiment of the present disclosure;

FIG. 10 shows a user interface according to an embodiment of the present disclosure;

FIG. 11 shows a user interface according to an embodiment of the present disclosure;

FIG. 12 shows a user interface according to an embodiment of the present disclosure;

FIG. 13 shows a user interface according to an embodiment of the present disclosure;

FIG. 14 shows a user interface according to an embodiment of the present disclosure;

FIG. 15 shows a user interface according to an embodiment of the present disclosure;

FIG. 16 shows a method for operating fantasy sports according to an embodiment of the present disclosure;

FIG. 17 shows a method for operating fantasy sports according to an embodiment of the present disclosure; and

FIG. 18 depicts an apparatus, in accordance with some example embodiments of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In an embodiment, the present disclosure provides a system and method for organizing fantasy sports leagues, wherein an unlimited number of participants are placed into individual divisions. In another embodiment, the present disclosure provides a system and method for organizing fantasy sports leagues which calculate scores based upon historical data from a certain historical time period with available statistics. The present disclosure also provides a system for playing fantasy sports with a large number of participants. The present disclosure also allows participants to play fantasy sports year-round even during off seasons. The present disclosure also provides wagering opportunities based upon fantasy sports performance and competitions.

In an embodiment, the present disclosure provides a system and method for organizing fantasy sports leagues, wherein an unlimited number of participants are placed into individual divisions.

According to an embodiment, when participants are placed into tournament brackets after the completion of the regular season, they will take their regular season fantasy team roster with them into the tournament bracket.

According to another embodiment of the present invention, the fantasy sports league allows and incorporates wagering. In this embodiment, participants may place wagers on the outcome of any head-to-head competition within the fantasy sports league. Participants may place wagers on any outcome related to the fantasy competition.

Sports simulations may include sports nodes providing a user interface for players to participate in a sports simulation. A user interface for a player to interact with the sports service may be hosted on a desktop computer, laptop commuter, notebook computer, netbook, personal digital assistant, smartphone, and/or any other computing device. The sports service providing the sports simulation may be hosted on a server. The user at the user interface of the computing device may interact with the sports service via a network and/or the Internet. The user interface may be a dedicated sports service application (also referred to as an “ap” or “app”), or the user interface may be web based and accessed via a web browser. Multiple players may interact on their computing devices with the sports service. For example, one of the multiple players may access the sports service on their smartphone using the dedicated app, another player may access the sports service on their netbook via a web browser, and another player may access the sports service on their desktop computer via a web browser. The multiple players may interact in one simulation, or may interact in multiple simulations, or may each interact with the sports service in solo simulations. Players may be matched in pairs where each pair plays a simulation to determine a winner. A user's computing device and the sports app or web browser configured to interface with the sports service may be referred to as a sports node.

Players of the sports service may connect from their sports nodes to the sports service through a wired or wireless network interface included in their computing device and a network and/or the Internet. Messages may be passed from the user interfaces at the sports nodes to the sports service. The messages may include data packets containing information related to the sports simulation such as athlete (e.g. football player, basketball player, etc.) information including historical play and/or statistical information regarding the athlete. The messages may contain financial information such as subscription, sports service account information, or wagering information including credit card and/or banking information. The messages may be encrypted to ensure privacy. For example, messages to a particular user's computing device may be encrypted using the Internet Protocol address of that particular computing device as an encryption key. Using an encryption key known to the user's computing device but not other players computing devices allows the user's computing device to decrypt the message without having a key passed from the sports server to the user's computing device. Other possible encryption keys include encrypting the message based on a user name and/or password or applying a hash function to the login, password, IP address, and/or other information to generate an encryption key. In some example embodiments, a player may be required to wait for another player to make a decision such as a play decision or team selection decision. An electronic token may be passed to the sports node where the corresponding player needs to make a decision. The other players may wait for the deciding player before they can make a play decision. When the player with the token makes the decision, that deciding player's sports node may pass the token to another player's sports node to make the next decision. In this way, the token identifies from which sports node the simulation is waiting for a decision and prevents collisions of decisions from sports nodes of players making simultaneous or near-simultaneous decisions. Simultaneous or near-simultaneous decisions may cause confusion and/or uncertain simulation results.

A sports service performing a multiplayer sports simulation may interface through a network and/or the Internet to the multiple sports nodes and corresponding players. The simulation may include multiple simulation steps where each player may make decisions about the athletes used on their team and the next simulation move or play for their team. In order to execute multiple simulation steps quickly so that the simulation players stay engaged, the sports service, network/Internet, and sports node browsers/aps may be required to provide a predetermined quality of service (QoS). The QoS may include a maximum latency, minimum data rate, and/or maximum or minimum packet size for sports service messages. The quality of service parameters may be passed from the sports server to the network and/or to the individual sports nodes.

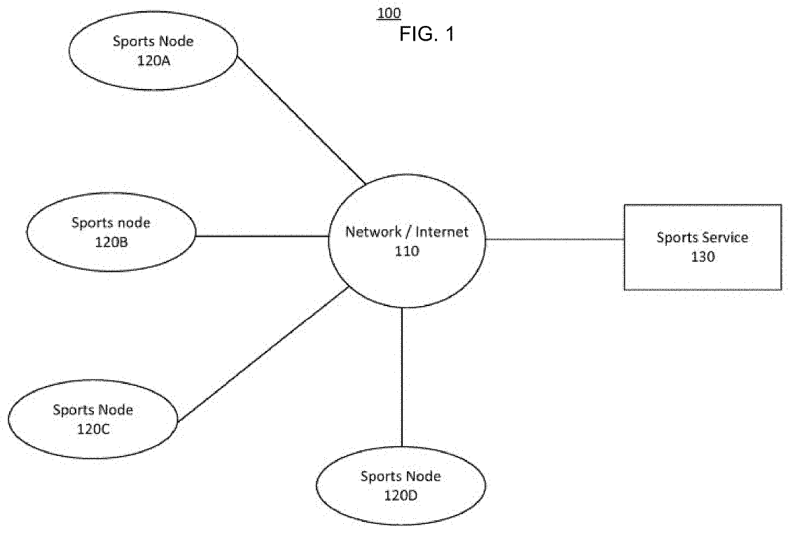

FIG. 1 depicts a sports service 130 connected through a network/Internet 110 to one or more sports nodes 120 operating in one or more simulations. In the example of FIG. 1, four sports nodes 120A, 120B, 120C, and 120D may connect through network/Internet 110 to a sports service 130 hosted on a server. Although FIG. 1 depicts four sports nodes, any other number of sports nodes may connect through network/Internet 110 to sports service 130. In the example of FIG. 1 sports node 120A may be matched with sports node 120D for a simulation and sports node 120B may be matched with sports node 120B for a simulation.

Sports nodes 120A-D may include any type of computing device such as a desktop computer, laptop computer, notebook computer, personal digital assistant, netbook, smartphone, or any other computing device. Sports nodes 120A-D may include web browsers or specific applications to interface with the sports service 130. Sports nodes 120A-D may include a user interface screen and a method of user input. Sports nodes 120A-D may include one or more wired or wireless interfaces that may interface with network/Internet 110. Wired interfaces may include a universal serial bus interface, Ethernet interface, or any other wired interface. Wireless interface may include WiFi (any of the IEEE 802.11 family of standards), WiMAX (any of the IEEE 802.16 family of standards), Bluetooth, cellular 2G/3G/4G/5G/GSM interface, or any other wireless interface.

Network/Internet 110 may include any combination of wired and wireless interfaces that route messages from the sports nodes 120A-D to sports service 130.

Sports service 130 may include executable instructions or software running on a server. The sports service 130 may provide a web interface for the sports nodes 120A-D and may provide an interface for a sports service application that may be installed on one or more of the sports nodes. The sports service may include an interface for management of the sports service such as establishing and/or deleting or suspending user accounts. The sports service 130 may provide data encryption for messages passed to and/or from the sports nodes and may support tokens as described above. Sports service 130 may include a database of athletes in one or more sports.

The sports service 130 may include detailed information about the historical performance of athletes, teams, managers, coaches, or the like. For example, a sports service directed at football may include all athletes that played the game between predetermined years, or a subset of players. For example, a football sports service may include all football players that played between 1960 and 2020. Associated with each player may be performance metrics or a history of the plays made by the players. For example, information about the players may include yards rushed, number of touch downs, tackles, field goals, and distances, and so on. For fantasy leagues based on a current season, the sports service 130 may obtain relevant statistics and metrics as the real life games occur or shortly thereafter.

The manager or owner of the team (user at a sports node) may select player lineups and which plays may be run in the simulation. In some example embodiments, a simulation involves managing and/or coaching a team roster, and/or calling plays and making strategic decisions. In some example embodiments, a simulation involves utilizing the athletes' actual performance.

Fantasy sports is the concept of creating virtual teams of real athletes and using their actual performance/statistics to compete with other virtual teams. Fantasy sports may be seasonal competitions with a draft to select players from professional sports teams create individual fantasy sport teams as part of a fantasy sports league. Leagues may be formed amongst friends, co-workers, and acquaintances online with drafts occurring prior to the start of a professional sports season.

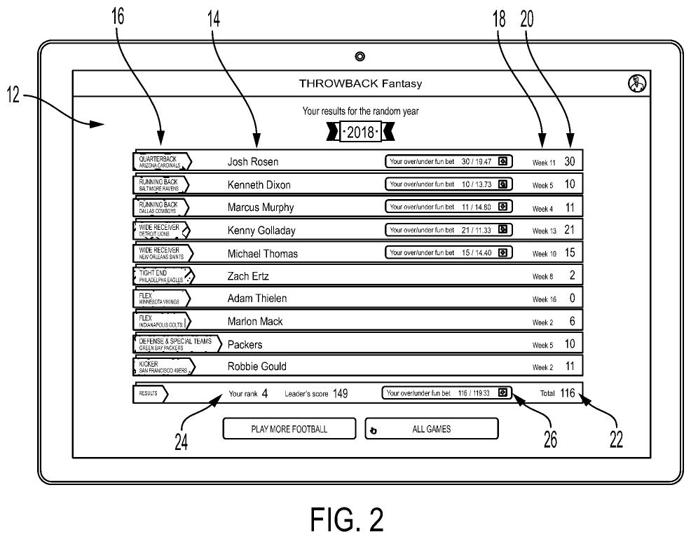

FIG. 2 shows a user interface according to an embodiment the present disclosure. According to an embodiment, a participant enters a fantasy sports league 10 and views the fantasy roster 12. The fantasy roster 12 includes a number of fantasy players 14 at a number of positions 16. A participant may select from a number of players 14 from a given position 16. During an assigned week 18, each player 14 earns an individual point value 20 based upon performance during the assigned week 18. Each player's 14 individual point value 20 is added into a total score 22 for the assigned week 18. The total score 22 is compared to other participant's total scores to provide a rank 24. According to an embodiment of the present invention, a participant may place wagers 26 on a number of items. FIG. 1 shows wagers 26 placed on the individual point value 20. In other embodiments, wagers 26 may be placed on total score 22, rank 24, etc. According to an embodiment of the present invention, the assigned week 18 is from any week or month (or other period) within a past season with recorded statistics. According to another embodiment, the assigned week 18 corresponds to a real time week.

FIG. 2 shows a user interface according to an embodiment of the present disclosure. According to an embodiment, a participant places a wager 26 on a number of player's 14 individual point value 20. According to an embodiment, the participant places a wager 26 on the total score 22. The wager 26 may be an over/under wager, spread wager, proposition wager, money line wager, parlay wager, etc.

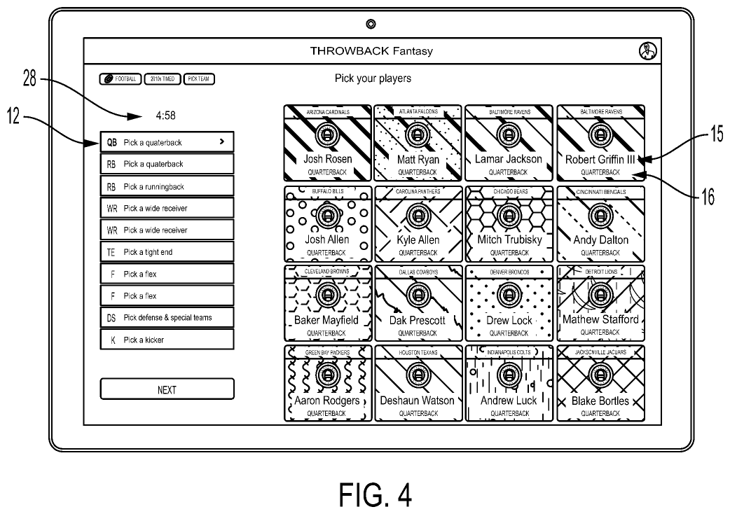

FIG. 4 shows a user interface according to an embodiment of the present disclosure. According to an embodiment, upon entering a fantasy sports league 10 a participant fills its roster 12 by selecting draftable players 15 from each position 16. In some embodiments, the participant has a timer 28 setting a designated length of time to select draftable players 15.

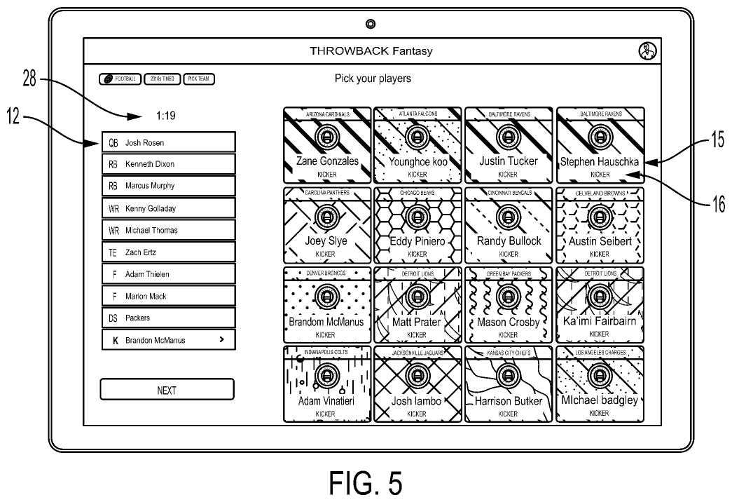

FIG. 5 shows a user interface according to an embodiment of the present disclosure. According to an embodiment, upon entering a fantasy sports league 10 and selecting draftable players 15, the participant's roster 12 displays the selected players 14 for each position 16. According to an embodiment, if the participant does not fill the roster 12 with draftable players 15 for each position 16 upon the expiry of the timer 28, draftable players 15 for the remaining positions 16 are randomly selected.

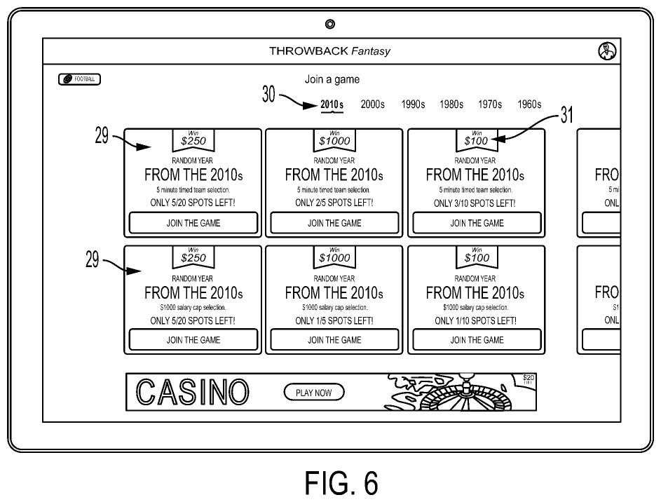

FIG. 6 shows a user interface according to an embodiment of the present disclosure. According to an embodiment, a participant selects a virtual room 29 from a number of available virtual rooms 29. According to an embodiment, a user must pay a certain entry fee 31 to join the virtual room 29. According to an embodiment, the virtual room 29 uses historical data of actual competition results from a certain historical time period 30 with available statistics. According to an embodiment, the historical time period 30 is a decade. When a participant selects a historical time period 30, the participant is not aware of which year or week from which statistics will be used to calculate a player's fantasy score. After each player in the virtual room 29 has filled its roster 12 by selecting draftable players 15 from each position 16, and optionally placed wagers on various outcomes, the system calculates each player's 14 individual point value 20 and total score 22 using the historical competition data from the chosen year and week (which now may be revealed to the players). Prizes may be awarded to players with the highest scores.

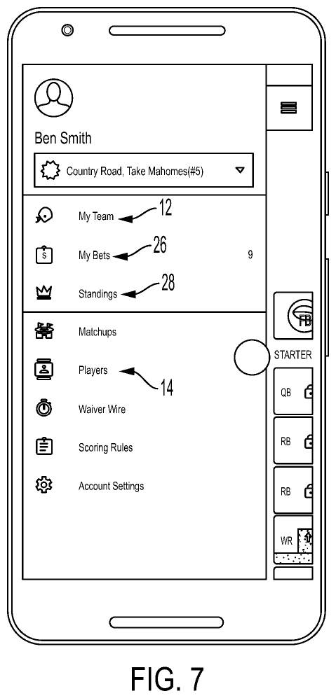

FIG. 7 shows a user interface according to an embodiment of the present disclosure. According to an embodiment, a participant navigates through the interface to view the roster 12, wagers 26, rank 24 and available players 14.

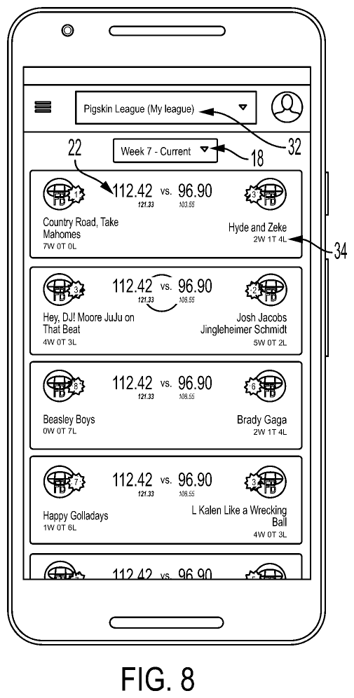

FIG. 8 shows a user interface according to an embodiment of the present disclosure. According to an embodiment, the participant is assigned to a certain division 32. The divisions 32 feature a number of head to head matchups 34 within each week 18. In each head to head matchup 34 the participant with the higher total score 22 wins the head to head matchup 34.

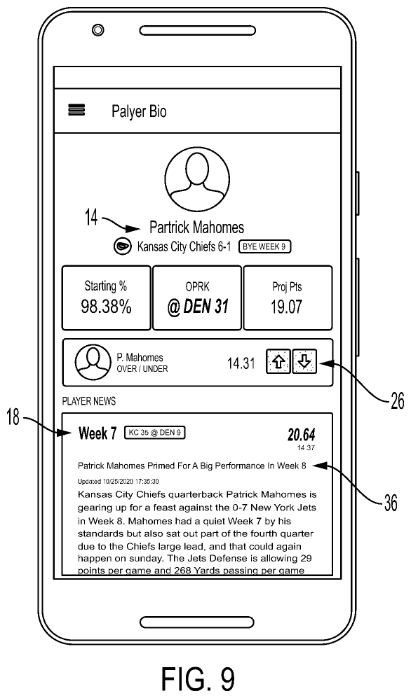

FIG. 9 shows a user interface according to an embodiment of the present disclosure. According to an embodiment, the user interface displays information regarding each individual player 14, including player news 36. According to an embodiment, a participant may place a wager 26 upon the players projected points for a given week 18.

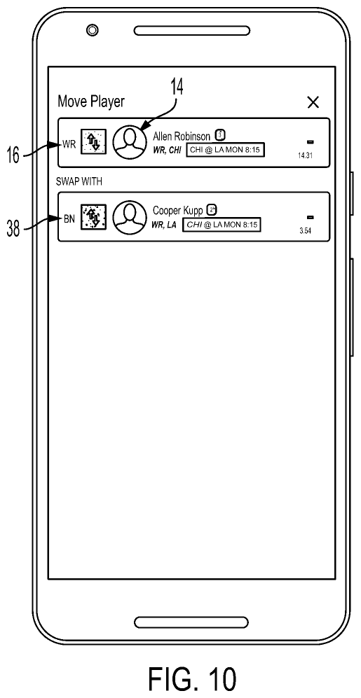

FIG. 10 shows a user interface according to an embodiment of the present disclosure. According to an embodiment, a participant's roster 12 includes a bench 38 with players 14 whose individual scores 20 are not included in the team's total score 22. A participant manages its roster by moving players 14 from positions 16 on the roster 12 to the bench 38 and vice versa.

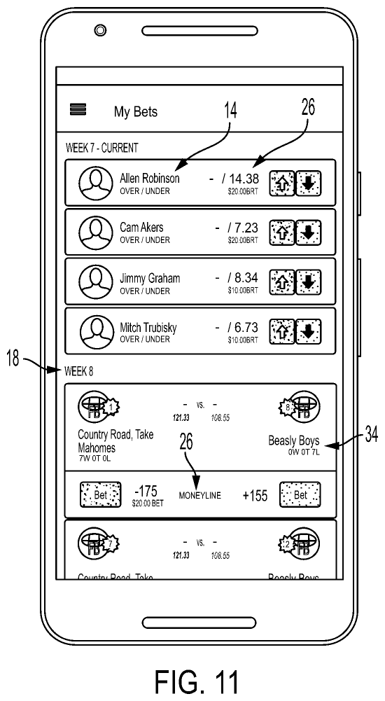

FIG. 11 shows a user interface according to an embodiment of the present disclosure. According to an embodiment, in a given week 18 a participant places wagers 26 on a number of options, including individual scores 20 for players 14 or head to head matchups 34.

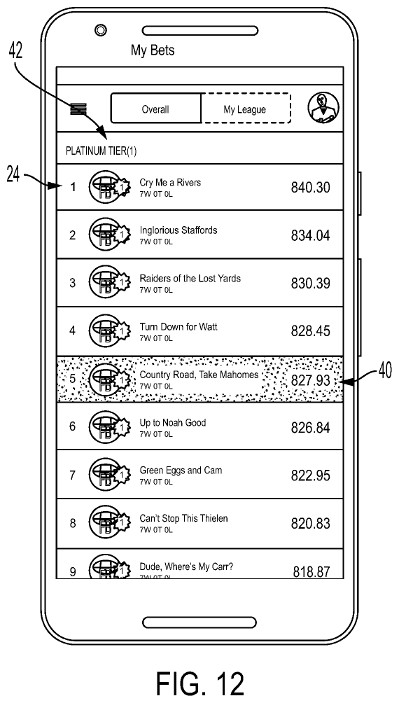

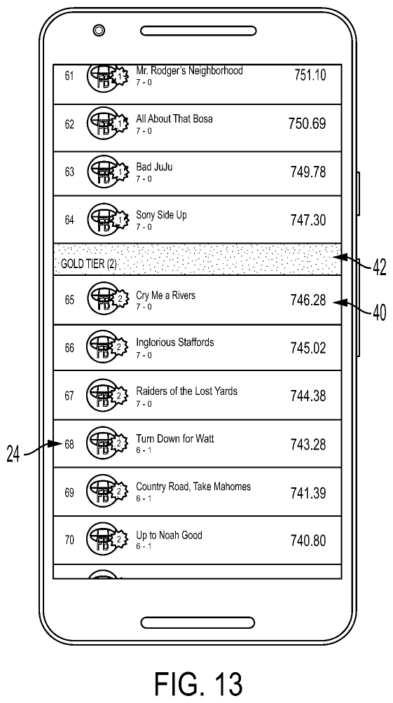

FIGS. 12 and 13 show a user interface according to an embodiment of the present disclosure. According to an embodiment, the participant's total scores 22 for each week 18 are added for a season running total 40. A participant's season running total 40 is compared to other participant's season running total's 40 to generate a rank 24. The rank 24 is used to organize all participants into a tier 42.

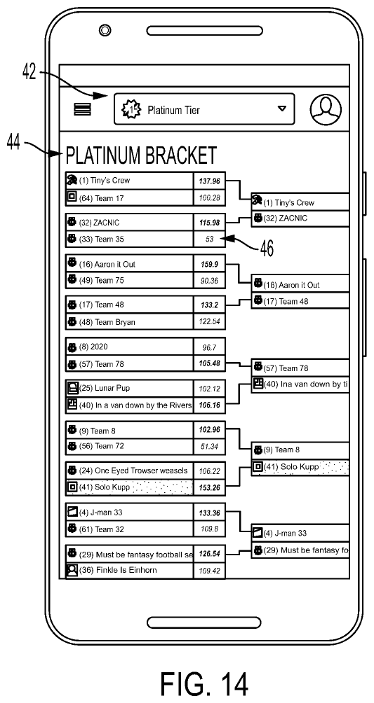

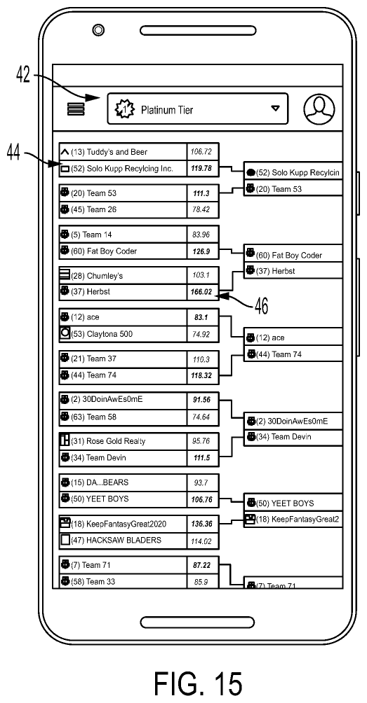

FIGS. 14 and 15 show a user interface according to an embodiment of the present disclosure. According to an embodiment the tiers 42 are organized into a tournament bracket 44. According to an embodiment, the tournament bracket 44 seeds a participant in the tier 42 by rank 24 such that the participant with the most favorable rank is matched with the participant with the least favorable rank in a tournament head to head matchup 46. According to an embodiment the winner of each tournament head to head matchup 46 advances to the next week of the tournament bracket 44.

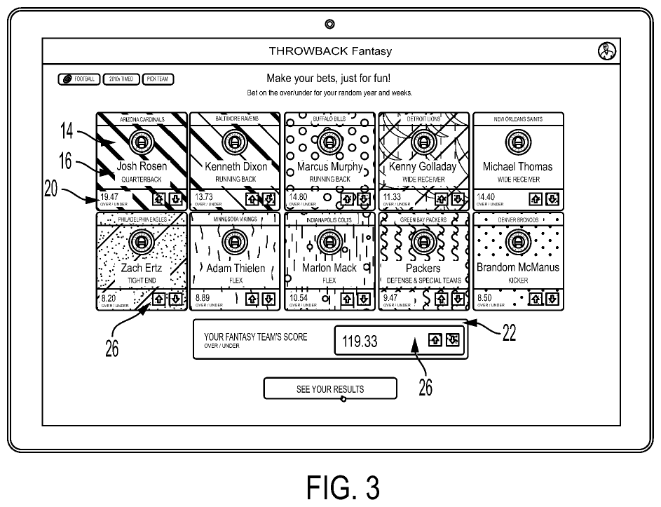

As may be appreciated by reference to FIGS. 2-15, the present disclosure provides a system and method for organizing fantasy football leagues, wherein an unlimited number of participants are placed into individual divisions 32. There may be an unlimited number of divisions 32. According to an embodiment, each participant pays an entry fee to join the fantasy sports league 10. Within each division 32, the participants will have their own fantasy draft, selecting real life players 14 from a real-life league. According to an embodiment, the real life league may comprise a football league such as the National Football League, a baseball league such as Major League Baseball, a basketball league such as the National Basketball Association or Women's National Basketball Association, a golf league such as the Professional Golfers' Association Tour, or any other real sports league. Once the fantasy draft occurs, each participant manages their roster 12 in a series of weekly or monthly (or any other interval) head-to-head competitions against the other participants within their division 32. These head-to-head competitions 34 within their division 32 make up the regular fantasy season. According to an embodiment, each participant is ranked within their division throughout the fantasy season based upon the results of their head-to-head competitions 34. In at least one embodiment, at the conclusion of the regular season, the participants from every division are placed into a series of tournament brackets 44.

According to an embodiment of the present invention, teams may be selected based upon a player salary system. In this embodiment, each player 14 is assigned a salary value based upon the desirability of that player. Participants are assigned a certain salary cap value with which to assemble their roster 12 of players 14. When selecting their team, the total salary value of the participant's roster 12 may not exceed the assigned salary cap. According to an embodiment, the player's salary value is based upon average fantasy points scored in previous years, predicted point values for a particular week or year, or any other metric for ranking players.

According to an embodiment, when participants are placed into tournament brackets 44 after the completion of the regular season, they will take their regular season fantasy team roster 12 with them into the tournament bracket 44. As a result, it is possible for there to be multiple instances of the same real-life players 14 named on different rosters 12 in a single playoff bracket 44 (since participants from different divisions may be placed into the same tournament bracket 44). The participants with the highest rankings 24 at the end of the regular season, will be placed in higher tier 42 tournament brackets 44 against participants which had similar rankings 24 from other divisions. According to an embodiment, each tournament bracket 44 may be assigned a ranking based upon the ranking of the participants placed in each tournament bracket 44. For example, the tournament bracket 44 with the highest ranked participants may be titled the gold bracket, while the next highest ranked tournament bracket 44 may be titled the silver bracket. According to an embodiment, the tournament brackets 44 containing teams with higher regular season rankings 24 will receive higher payouts or rewards for placement while the tournament brackets 44 containing teams with lower regular season rankings 24 will receive lower payouts or rewards for placement.

According to an embodiment, each tournament bracket 44 comprises sixty-four participants. In other embodiments, there may be more or fewer participants in each bracket 44. The entire fantasy league may contain as many tournament brackets 44 as necessary to place each participant in a tournament bracket 44. If there are not enough participants remaining to fill the last tournament bracket 44, then the remaining empty positions in the bracket will result in a corresponding participant in the tournament bracket 44 receiving a “bye” for that round of the bracket. At the conclusion of the tournament brackets 44 there will be one winning participant from each tournament bracket 44.

According to an embodiment of the present invention, participants will earn rewards for various accomplishments, such as winning divisions, winning individual weekly contests, placing first in the tournament brackets 44, obtaining the best regular season record, etc. The rewards may include predetermined financial payouts.

According to an embodiment of the present invention, the fantasy sports league 10 allows and incorporates wagering. In this embodiment, participants may place wagers 26 on the outcome of any head-to-head competition 34 within the fantasy sports league 10. Participants may place wagers 26 on any outcome related to the fantasy competition. For example, participants may place wagers 26 upon their own teams in a head-to-head competition 34, on other teams in a head-to-head competition 34, regular season rankings 24, the outcomes of other head-to-head competitions 34, etc. Wagers 26 may include any types of gambling, including but not limited to daily, perfecta, trifecta, pick two, pick three, pick four, pick six, etc. Additionally, non-participants in the league may place these wagers 26.

According to at least an embodiment of the present invention, the fantasy sports league comprises one or more virtual rooms 29 which allow for participation year-round, unrestrained by the schedule of the real-life sports league. According to this embodiment, a participant may pay an entry fee 31 to enter a fantasy sports virtual room 29. In some embodiments, each virtual room 29 allows a predetermined maximum number of participants to enter the virtual room. Once the virtual room is opened, a list of draftable players 15 is provided to each participant. The draftable players 15 are players from a real-life league; however, they may be from any week or month (or other period) within a past season with recorded statistics. All of the draftable players 15 in the draft will have been active during the period assigned to the virtual room 29. In some embodiments, the participant has a limited amount of time to select their team from the list of draftable players 15. For example, the participant may be given five minutes to select their team as one non-limiting example. The limiting of the time period for drafting limits the ability of the participant to conduct research to try to determine which time period is represented in this particular virtual room 29. Prior to and during the draft period, the time period from which the draftable players' 15 statistics will be drawn is not disclosed to the participants. Players 14 may also be chosen by a salary system, wherein each player 14 is assigned a salary and each participant must fill their roster 12 with players 14 without exceeding the assigned salary cap. Once each participant has selected his roster 12, the virtual room 29 calculates each participant's score based upon the statistics from a particular week or month (or other period) within a past sport's season. After the scores are calculated, the winner (or winners) is announced, and the virtual room 29 distributes winnings.

According to this embodiment, the fantasy sports virtual room, may use scores and players from any sports league, including but not limited to professional football, professional basketball, professional soccer, professional baseball, professional hockey, professional golf, and professional e-sports.

In another embodiment, once a participant in a virtual room 29 drafts all of the players 14 for their roster, the system displays to the participant the average points of each of the players 14 on their roster 12 for the year containing the period represented by the virtual room 29. At this point, the participant still does not know which week, month or other period within that year is represented by the virtual room 29. The participant then has the ability to place a wager 26 on a team, player 14, or both a team and player 14, prior to seeing the results of the fantasy matchups for that period. Once the wagers 26 are placed, participants can receive payouts for winning (or other placements) against other rosters 12 within the virtual room 29, as well as payouts for any wagers 26 the participant has placed.

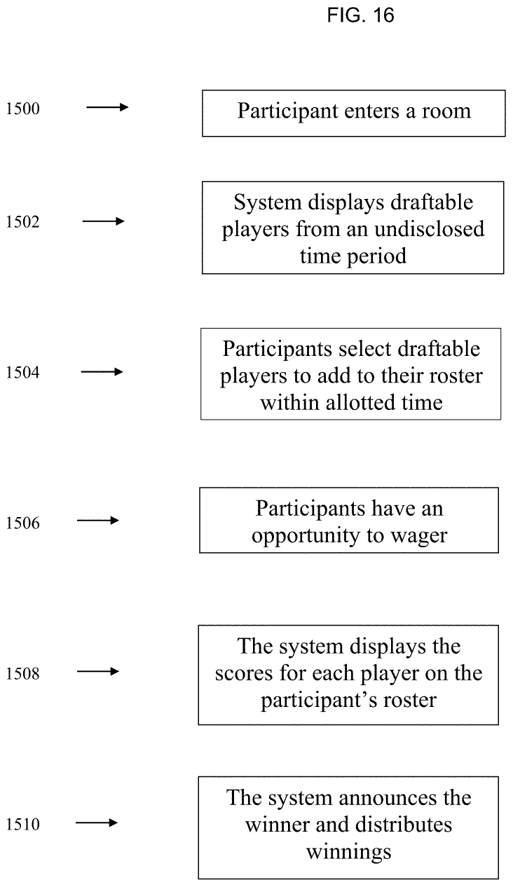

FIG. 16 displays a method for managing fantasy sports leagues according to an embodiment of the present disclosure. According to an embodiment, participants enter virtual room 1500. Each virtual room may require a certain fee for entry. Each virtual room may also be assigned to a certain set time period with available statistics. According to an embodiment, the system then displays to the user a number of draftable players from an undisclosed year and week within a given time period 1502. Next, participants are given a limited amount of time select draftable players to add to their roster within 1504. Upon selection of teams, participants have an opportunity to wager 1506. After the wager period expires, the system displays the scores for each participant 1508. According to an embodiment, the system then determines and announces the winning participant and distributes winnings 1510.

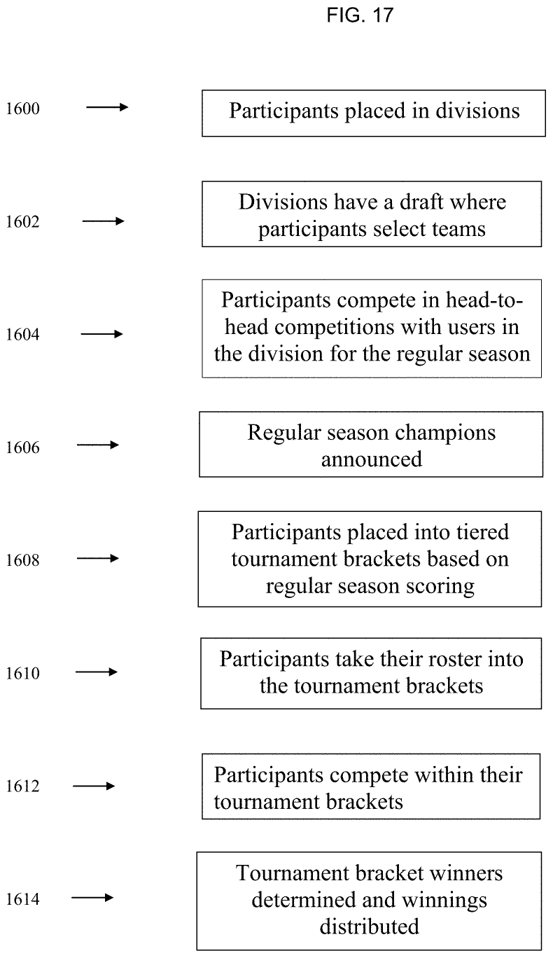

FIG. 17 displays a method for managing fantasy sports leagues according to an embodiment of the present disclosure. According to an embodiment, participants are first placed in divisions 1600. Participants may pay an entry fee to enter the division. Once in the divisions, participants draft players to fill rosters 1602. The draft may include a turn-based draft where the participants take turns selecting available players or a salary based draft where each participant bids on individual players and must fill a roster without exceeding a set salary cap. Once rosters are filled participants compete in head to head competitions with other participants in the division 1604. These head-to-head competitions within the division make up the regular season. At the conclusion of the regular season, regular season champions are announced 1606. According to an embodiment, participants are placed into tiered tournament brackets based upon their regular season scoring 1608. According to another embodiment, participants are placed into tiered tournament brackets based upon regular season ranking. According to an embodiment, participants take their regular season roster into the tournament brackets 1610. Participants then compete in head-to-head competitions with other participants within their tournament brackets 1612. At the conclusion of the tournament, tournament bracket winners are determined, and winnings are distributed 1614.

The present disclosure provides a system that may be operated as a fantasy sports league service through a network/internet and connected to one or more participant nodes operating in one or more simulations. For example, multiple participant nodes may connect through network/Internet to a fantasy sports service hosted on a server. One or more participant node(s) may be matched with other participant node(s) for a competitive simulation.

The participant nodes may include any type of computing device such as a desktop computer, laptop computer, notebook computer, personal digital assistant, netbook, smartphone, or any other computing device. The participant nodes may include web browsers or specific applications to interface with the fantasy sports league service. The participant nodes may include a user interface screen and a method of user input. The participant nodes may include one or more wired or wireless interfaces that may interface with a network/Internet. Wired interfaces may include a universal serial bus interface, Ethernet interface, or any other wired interface. Wireless interface may include Wi-Fi (any of the IEEE 802.11 family of standards), WiMAX (any of the IEEE 802.16 family of standards), Bluetooth, cellular 2G/3G/4G/5G/GSM interface, or any other wireless interface.

The network/Internet may include any combination of wired and wireless interfaces that route messages from the participant nodes to the fantasy sports league service.

The participant nodes may include executable instructions or software running on a server. The fantasy sports league service may provide a web interface for the participant nodes and may provide an interface for a fantasy sports league service application that may be installed on one or more of the participant nodes. The fantasy sports league service may include an interface for management of the fantasy sports league service such as establishing and/or deleting or suspending user accounts. The fantasy sports league service may provide data encryption for messages passed to and/or from the participant nodes and may support tokens as described above. The fantasy sports league service may include a database of athletes in one or more sports.

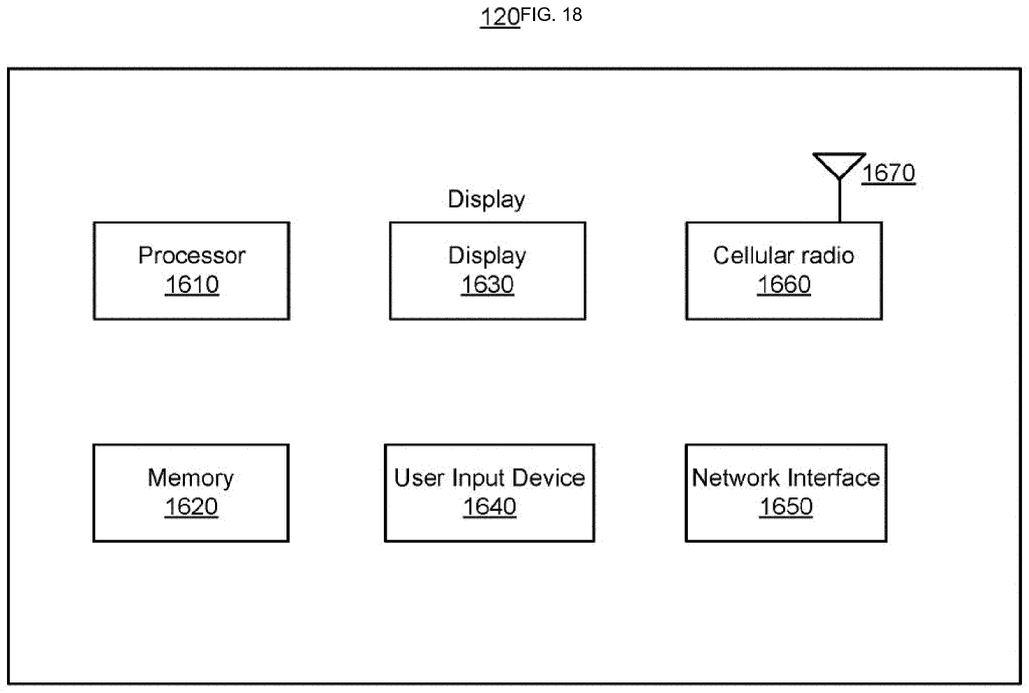

FIG. 18 depicts a sports node apparatus, in accordance with some example embodiments. Sports node 120 (such as one or more of sports nodes 120A-D may include processor 1610, memory 1620, display 1630, user input device 1640, network interface 1650, cellular radio 1660, and/or antenna 1670.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor such as processor 1620, which can be special or general purpose, coupled to receive data and instructions from, and to transmit data and instructions to, a storage system, at least one input device, and at least one output device. The programmable system or computing system may include clients and servers. A client and server are generally remote from each other and may interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable medium” refers to any medium such as memory 1620 used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device such as display 1630 which may include for example a cathode ray tube (CRT) or a liquid crystal display (LCD) or a light emitting diode (LED) monitor for displaying information to the user. A user input device such as user input device 1640 may include a keyboard and/or a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Sports node 120 may include network interface 1650. Wired interfaces may include a universal serial bus (USB) interface, Ethernet interface, or any other wired interface. Wireless interface may include WiFi (any of the IEEE 802.11 family of standards), WiMAX (any of the IEEE 802.16 family of standards), Bluetooth, or any other wireless interface.

Sports node 120 may include cellular radio 1660. Cellular radio 1660 may interoperate with any cellular telephone standard including, but not limited to 2G/3G/4G/5G/and/or Global System for Mobile Communications (GSM) interface.

What is claimed is:

1. A system for operating fantasy sports leagues played by a plurality of participants, the system comprising a plurality of nodes configured to act as a client on a network; a server configured to communicate with the plurality of nodes over the network, the server comprising: at least one programmable processor; and a machine-readable medium storing instructions that, when executed by the at least one programmable processor, cause the at least one programmable processor to perform operations comprising:
creating at least one virtual room; and
a set of draftable players with respective historical statistics,
wherein the participants each select a roster of draftable players from the set of draftable players to build a subset roster of drafted players,
wherein the respective historical statistics comprise data based upon each respective drafted player's performance during a predetermined and undisclosed time period, and
wherein the virtual room assigns point values to the drafted players based upon the drafted player's performance during the predetermined and undisclosed time period.

2. The system of claim 1, wherein the virtual room determines a winning participant and distributes rewards to the participants.

3. The system of claim 1, wherein participants must pay a fee to enter the virtual room.

4. The system of claim 1, wherein participants are afforded an opportunity to wager upon any fantasy sports related outcome.

5. The system of claim 1, wherein the participants have a limited amount of time to select players from the draftable players.

6. The system of claim 1, wherein the virtual room determines a winning participant and distributes rewards to the participants.

7. The system of claim 1, wherein the participants have a limited amount of time to select players from the draftable players

8. The system of claim 1, wherein the drafted player's performance comprises a specified one-week period during the undisclosed time period.

9. A method for operating fantasy sports leagues on computer implemented application on a network comprising a plurality of nodes, the method comprising:
allowing participants to enter a virtual room;
displaying draftable players from an undisclosed time period
conducting a draft wherein participants select players from the draftable players to build a roster of drafted players;
assigning scores to each drafted player based upon the drafted player's performance during the undisclosed time period.
calculating scores for each roster based upon historical statistics for each drafted player; and
comparing the scores of each participant.

10. The method of claim 9 wherein, the undisclosed time period comprises any historical time period with recordable statistics.

11. The method of claim 9 further comprising announcing a winner and paying out based upon the scores.

12. The method of claim 9 wherein participants must pay a fee to enter the virtual room.

13. The method of claim 9 wherein participants are afforded an opportunity to wager upon any fantasy sports related outcome.

14. The method of claim 9 wherein the participants have a limited amount of time to select players from the draftable players.

15. The method of claim 10 wherein the undisclosed time period comprises a historical decade with recordable statistics

16. The method of claim 9 wherein the drafted player's performance comprises a specified one-week period during the undisclosed time period.

17. A method for operating fantasy sports leagues on computer implemented application on a network comprising a plurality of nodes, the method comprising:
Placing participants into divisions;
Conducting a draft for participants to select teams;
Placing participants into head-to-head competitions with participants within the division for the regular season;
Calculating scoring for each participant based upon the performance of the participant's roster;
Announcing regular season placements based upon the results of each head-to-head competition;
Placing participants into tiered tournament brackets based upon regular season performance;
Determining winners of each tiered tournament bracket and distributing winnings.

18. A system for operating fantasy sports leagues played by a plurality of participants, the system comprising a plurality of nodes configured to act as a client on a network; a server configured to communicate with the plurality of nodes over the network, the server comprising: at least one programmable processor; and a machine-readable medium storing instructions that, when executed by the at least one programmable processor, cause the at least one programmable processor to perform operations comprising:
creating at least one virtual room; and
a set of draftable players with respective historical statistics,
wherein the participants each select a roster of draftable players from the set of draftable players to build a subset roster of drafted players,
wherein the respective historical statistics comprise data based upon each respective drafted player's performance during a predetermined and undisclosed time period, and
wherein the virtual room assigns point values to the drafted players based upon the drafted player's performance during the predetermined and undisclosed time period; and wherein participants are afforded an opportunity to wager upon any fantasy sports related outcome comprising the performance of another participant.

19. A method for operating fantasy sports leagues on computer implemented application on a network comprising a plurality of nodes, the method comprising:
allowing participants to enter a virtual room;
displaying draftable players from an undisclosed time period
conducting a draft wherein participants select players from the draftable players to build a roster of drafted players;
assigning scores to each drafted player based upon the drafted player's performance during the undisclosed time period.
calculating scores for each roster based upon historical statistics for each drafted player; and
comparing the scores of each participant; and wherein participants are afforded an opportunity to wager upon any fantasy sports related outcome comprising the performance of another participant.
